(19) United States
(12) Patent Application Publication
(10) Pub. No.: US 2002/0055851 A1
(43) Pub. Date: May 9, 2002

(54) Military installment loan and educational services system

(76) Inventors: Donald L. Jacobs, Lexington, KY (US); Joseph S. Minor, Lexington, KY (US)

Correspondence Address: KING & SCHICKLI, PLLC, 247 NORTH BROADWAY, LEXINGTON, KY, 40507, US

(21) Appl. No.: 09/917,474

(22) Filed: Jul. 27, 2001

Related U.S. Application Data
(60) Provisional application No. 60/222,097, filed on Jul. 28, 2000.

(51) Int. Cl. G06F 17/60

(52) U.S. Cl. 705/1

(57) ABSTRACT

A system or method is disclosed for facilitating the purchase of a product, including a vehicle, to be financed for an end-user individual, such as a member of the military. An approved network of suppliers is provided and maintained including certification in criteria to meet the needs of the individual. Each individual is educated in personal finances and related principles as a prerequisite for approval to purchase the product through the system. A working liaison relationship is established with the military. The system provides representation that assists in obtaining the financing through an installment loan program from an approved member of a financial institution network. Other features of the system/method include a purchase application, a loan disclosure video, verifying the employment and projection of income, assisting in the selection of the vehicle, personal as well as on-line instruction and supplier training and monitoring. As another enhancement, an onsite facility is provided. A limitation of eligibility as to the vehicle selection is provided by limiting the installment loan payment to approximately 30% of income. The individual is assisted in establishing good credit history, purchasing of insurance, reliable servicing of the loan and exit counseling upon leaving the military. Supplier performance assurances are required to meet after-sale requirements of the system.

### BACKGROUND OF THE INVENTION

In the field of financing big ticket products, especially vehicles, we have discovered that one group of deserving individuals have been overlooked in terms of having a system that fairly meets their needs. Specifically, these individuals are enlisted service members of the U.S. Miliary. What has been found through research, is that by and large these individuals do not have a readily available source where they can receive balanced guidance and service availability for money management and financial principles, access to reliable vehicle dealers to obtain affordable transportation and access to competitive loan rates. In the past, this group of individuals has been stuck with limited choices, and on occasion overpriced vehicles of questionable quality by a few unscrupulous dealers. In addition, unfavorable and unclear financing terms and inflated interest rates sometimes add to the frustration of the individuals that are a part of this group.

Ironically, these young enlisted service members have significant advantages and strengths when it comes to being an ideal customer for financing and purchase of a product, such as a vehicle. To begin with, these individuals have a verifiable steady and secure employment, that is generally not subject to economic downturns. Their income and benefits are continuous and are subject to automatic annual increases. These individuals are disciplined through structured living and working environments and are known for high standards for enlistment, including 98% that are high school graduates as well as 41% with some college background. In reality, the disposable income of the service member is approximately 12% more than their civilian counterparts due in large part to the generous military fringe benefits package that provides: (1) medical, dental, optical, hearing, life insurance and disability benefits; (2) housing, meal and clothing allowances; and (3) accessibility to military exchanges and commissaries offering price savings on products and services ranging from 18-27%.

Heretofore, there has been no system where the military organization, reputable financial institutions and reputable automobile dealers have been partnered together so as to assure a systematic way of meeting the needs of enlisted service members for big ticket products. While the military command agrees in theory that it would be good to provide these individuals with balanced guidance and service availability to assure good value in the purchase of a vehicle, there has been no one to step forward to solve the puzzle and actually get it done. Heretofore, among the missing parts is a complete educational program for the members so as to provide a more complete understanding of all aspects of the transaction.

Thus, a comprehensive program is needed that is structured to encompass and balance the needs and strengths of both these individuals, and the group as a whole, along with the needs and strengths of the vehicle dealerships and financial institutions. Such a system would serve in facilitating the purchase of affordable, financed vehicles by end-user individuals, including service members, that are a part of a closed group, such as the U.S. Military. To accomplish this objective a first step would be to organize a network of dealerships that are required to be certified in criteria relating to affordable and reliable transportation. An important factor on the other side of the coin is providing an organized method for educating the service member or individual in principles of finance and responsibility. Other important factors to be considered include organization of a network of reputable financial institutions, and representation within the system to assist the group member in obtaining the financing and managing the loan program once established.

### SUMMARY OF THE INVENTION

With the above background and needs for improvement in the business method technology for facilitating the purchase of affordable, financed vehicles, and thus in accordance with the purposes of the present invention as described herein, the military installment loan and educational services system is created. A first step toward implementation of such a system is providing and maintaining a qualified improved network of vehicle dealerships. To be a member of the network, the dealer must have the full financial backing of a manufacturer's franchise or provide a substantial performance bond, among meeting other basic obligations, such as pricing and product quality standards, as well as with regard to representations and warrants, all for the purpose of meeting the needs of the end-user individual or service member in the group. Next, as an important component of the facilitating system is educating the individual in personal finances and related budgeting principles. This is established as a prerequisite for approval to purchase a vehicle within the system.

In order to carry out the objective of obtaining balanced guidance, the system envisions establishing a working relationship with the military, which of course is a closed group in that the general public is not entitled to participate as a member. Representation within the system is charged to assist in obtaining the financing for the vehicle through an installment loan program of an approved financial institution. Thereafter, the representative of the system keeps in touch with the member for any assistance needed in managing the loan program. At present, the Moral, Welfare and Recreation operations section, otherwise identified by the acronym MWR, of the specific military base of the Department of Defense (DOD), is envisioned as the contact to help establish the system and liaison.

The system of the present invention covers the individual or service member being provided with an application for purchase of the vehicle and a loan disclosure video being presented for viewing. The employment of the individual is verified in another step of the system or method, as well as an income projection being generated. The member must enter and complete the formal educating step. A strong feature of the education of the individual concerns the personal instruction that the individual is given, as well as the provision of on-line self-instruction concerning financial and budgeting matters over a global computer network. Later, the individual can be assisted in how to best select the vehicle from the inventory of one of the dealerships that has qualified as a supplier under the rules of the system.

To ensure dealership reliability and integrity, the system contemplates training, monitoring performance and assisting in resolving disputes. Furthermore, an added advantage is realized when an on-site facility is established to allow direct contact with the individual making the purchase. This facility may include display of vehicles and other automotive products, but most importantly provides another resource for general information about the system.

The system also envisions important features to assure efficient operation and a mutually beneficial relationship between all of the parties involved. Qualification under the loan program is limited to a payment schedule of approximately 30% of the individual's gross-base pay. The individual is assisted by the system in establishing good credit history, prompt payment and loan servicing and exit counseling upon leaving the military. An important factor in providing and maintaining the approved dealership network is establishment of a wide range of criteria in addition to pricing and product quality, such as meeting of after-sale requirements, along with certain levels of manufacturer's warranty and service contract. Taken together this is effective to help establish and maintain the integrity of the dealership network, and in turn the overall system.

Still other objectives and advantages of the present invention will become readily apparent to those skilled in the automotive, as well as the general, business method art from the detailed description that follows, simply by way of illustration of the mode best suited to carry out the invention. As will be realized, the invention is capable of other embodiments such as with respect to purchase of other financed, big ticket products and with respect to other closed groups, and the method of the invention and its several details are capable of modifications in various, obvious aspects all without departing from the invention. Accordingly, the drawings and description herein will be regarding as illustrative in nature and not as restrictive.

### BRIEF DESCRIPTION OF THE DRAWINGS

Reference will now be made in detail to the preferred embodiment of the invention, which is illustrated in the accompanying drawings:

FIG. 1 is a flow chart illustrating in general, broad terms how to carry out the preferred embodiment of the invention involving facilitating the purchase and financing of a vehicle through a certified dealer, including the successful completion of the training of the individual purchaser; and

FIG. 1A is a flow chart of the remainder of the system for facilitating the purchase of a vehicle from the point of establishing the installment plan loan to the completion of the process.

P Reference will now be made to the description of the preferred embodiment in detail to illustrate the present invention.

### DETAILED DESCRIPTION OF THE INVENTION

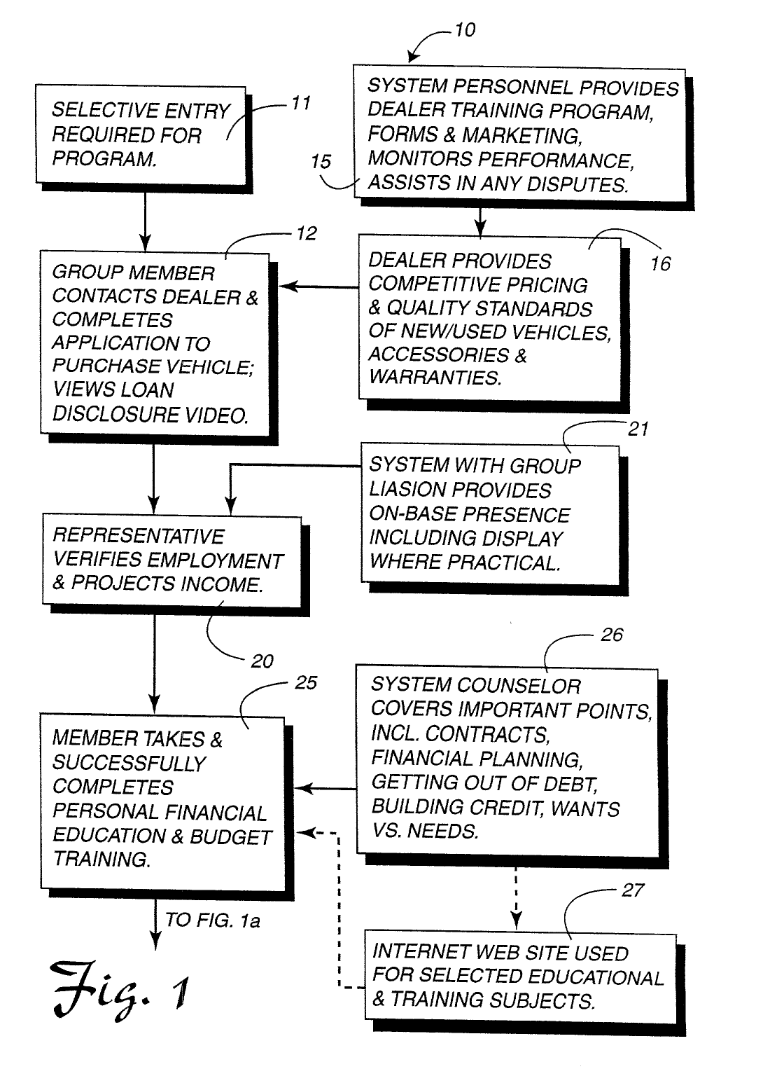

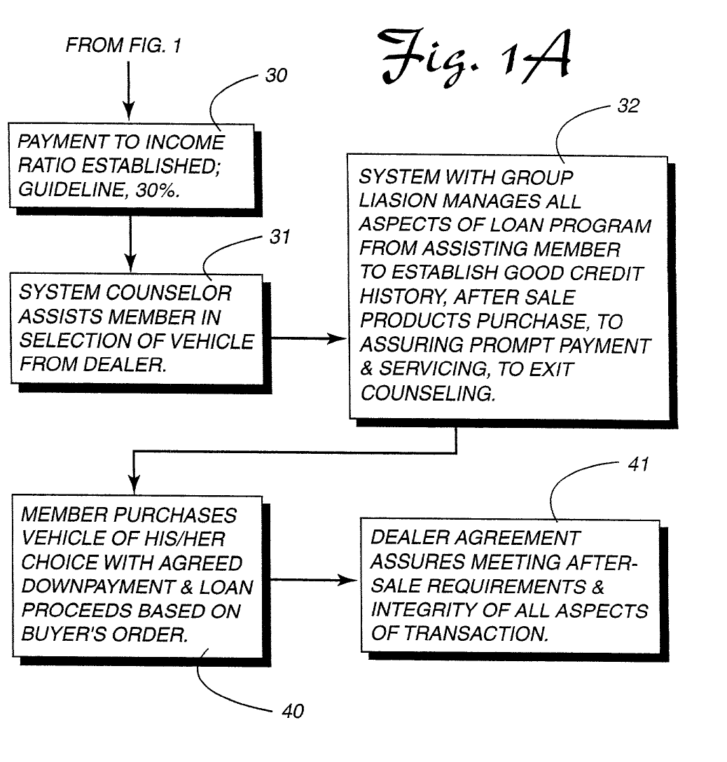

With reference specifically to FIG. 1 of the drawings, there is illustrated a system 10 designed in accordance with the principles of the present invention for facilitating the purchase of a financed product by end-user individuals, such as an enlisted service member. In the flow chart, the system 10 starts with the premise that it is adapted for a closed group, such as the U.S. Military, and in other words that there is a selective entry step 11 for participation in the program. After it is established that the group member or individual is qualified, the member can contact a dealer at step 12, where an application must be completed to purchase a product, such as a vehicle. In addition, the member or individual must take and pass the educational course. A loan disclosure video must be viewed before proceeding on to the next step. The application covers all of the standard information that must be supplied in order to determine the basic financial qualifications relevant to a vehicle purchase. The video is viewed at the dealership and describes general responsibilities that go with contracting for a vehicle installment loan. It is designed to reinforce and cover several topics including the impact of credit and how timely payments are necessary to build credit history, the importance of maintaining the vehicle once purchased and what should be done in the event of a problem arises with regard to a payment or with regard to the vehicle. To document the occasion of viewing the video, a disclosure acknowledgment form confirming that the video has been viewed and understood is preferably used.

The dealer in step 12 has already been certified in criteria to meet the needs of the end-user member in the group. This function occurs at step 15 of the system 10; namely, personnel of the provider of the system trains the dealer regarding all details and provides such important input as forms and marketing. In addition, in step 15 the system makes provision for the system personnel to monitor the performance of the dealers within the network and to assist in any disputes that might arise in the normal course of any transaction that is consummated within the system 10. As a result of the training, the dealer, as represented in block 16 is assured of providing the competitive pricing and quality standards of all new and used vehicles, as developed and taught by the personnel in step 15. In addition, the dealer in accordance with the requirements must be competitive with respect to accessories and warranties, as well as basic service needs.

In step 20, a representative of the system 10, verifies employment and projects income of the member or individual that is making the purchase. To make this step and subsequent steps easier and more meaningful, an alternative benefit can be provided where practical. This step 21 includes providing an on-base presence, and in those cases where practical even a vehicle display. The provider of the system 10 in this step partners or liaisons with the group from which the member comes. In the military environment, this liaison is typically with the MWR operations personnel of the U.S. Military base where the system 10 is being offered, and of course with one or more of the dealers that are a part of the network.

An important step within the system or method 10 involves the financial educational training of the service members and spouses in a formal setting in a more in depth manner with respect to personal finances and budgeting principles, as set forth in steps 25 and 26. Through this specific and focused educational training, the young service members and their spouses are better prepared in not only the field of handling money and budgeting for vehicle purchase and financing, but also in meeting ownership responsibility. The curriculum includes contractual agreements, how to develop family budgets and financial planning for the present and future, the best way to get out of debt that includes responsible balancing wants and needs, building a sound credit history and how following these guidelines provides for family harmony and a better quality of life.

In addition to personal instruction, which preferably is carried out on the military base, there is training via the Internet through a web site set up by the provider, and identified in step 27. This training, which of course is available at all times, is preferably used for selected educational and training subjects over and beyond the points taught at step 26 with regard to contracts, financial planning, credit building and the like. Both of these resources, including personal instruction at step 26 and instruction over the global computer network or the Internet, at step 27, work together to insure that the member is ready to assume the responsibility that goes with the purchase and financing of the vehicle. A certificate may be issued to memorialize the successful completion of these educational steps of the system 10.

Turning now to FIG. 1A, once the training certificate is in hand, the system 10 provider calculates at step 30 the installment loan payment that can be comfortably handled by the particular prospective purchaser. In the preferred embodiment, the payment income ratio is established by using standard procedures. As a preferred guideline, a limit of 30% of the gross base pay can go to the loan installment payment for the vehicle. With this figure in hand, a counselor of the provider may assist the member in selection of the vehicle at step 31 that meets the standards and criteria of the system. This assistance is just one more way to make certain that the service member does not overextend his or her capability to comfortably pay for the vehicle over the designated loan period.

Once the vehicle is selected, the benefits of the educational program of the system 10 is supplemented with active management within the system of all aspects of the loan program. Liaison or partnership is developed by the provider of the system 10 with a representative of the military, such as a MWR person of the DOD military base. As shown in step 32, this management has the objectives of assisting the member in the quest of establishing the good credit history, as taught earlier during the education step, taking care of the purchase and maintenance of insurance, as well as reinforcing the benefits of prompt payment and servicing of the loan. Exit counseling, if and when the service member is discharged, is also included.

The success of operation of the system 10 results in the member or individual successfully purchasing the vehicle of his or her choice, as represented by step 40 in FIG. 1A. The purchase is completed in a manner that represents affordable transportation for that particular member, and in a manner where the member has obtained the valuable balanced guidance and service availability needed for good value in the purchase. The steps of the system wherein a reputable network of dealers or suppliers are certified, the member is educated and a liaison relationship is established with the group itself, are all important factors in making the system 10 work. As a result and advantage of the system 10, the member is now assured of a purchase that can be handled based on a down payment and use of loan proceeds that best suit the criteria earlier established by taking into account the contributions of all parties.

Finally, the system 10 envisions the certified dealership meeting all after-sale requirement to maintain system integrity at step 41.

In summary, the system 10 provides facilitation of the purchase and financing of a product, especially adapted for the purchase and financing of a vehicle by enlisted members of the military. Key features include providing and maintaining an approved network of dealers that are certified in criteria to meet the needs of the service member, as represented in steps 15 and 16 of FIG. 1. Education of the member, as illustrated in steps 25-27, is operative to insure that the service member understands the necessary principles and requirements of the purchase, including financing requirements of the transaction so that the selection of the vehicle from the financial viewpoint is appropriate. An approved network of financial institutions, provided and maintained based on the pricing and quality requirements of the system, as set forth in step 32, is also an important factor. In addition, the cooperation and liaison with the military, such as MWR operations personnel of the military base, is an advantage with respect to these three factors, and can result in other enhancements, such as an on base presence to provide additional personal assistance, and to even provide a display of vehicles where practical, as set forth in step 21. Other important ancillary aspects of the system 10 include establishing the appropriate guidelines for the member's installment loan payment and assisting the member in selection of the vehicle, as set forth in steps 30, 31.

The foregoing description of the preferred system or method of the invention is presented for purposes of illustration and description. It is not intended to be exhaustive or to limit the invention to the precise form disclosed in the description including the drawings. Obvious modifications or variations are possible in light of these teachings. The specific environment of the military establishment or group and the enlisted service member is chosen and described to provide the best illustration of the principles of the invention. It is clear that its practical application is adapted in its broadest aspects to various other closed groups and end-user individuals, which adaptation is well within the capabilities of one of ordinary skill in the art of business methods. All such adaptations, modifications and variations are within the scope of the invention as determined by the appended claims when interpreted in accordance with the breadth to which they are fairly, legally and equitably entitled.

1. A system for facilitating the purchase of an affordable, financed product by end-user individuals in a closed group comprising the steps of:
providing and maintaining an approved network of suppliers of the product that are certified in criteria to meet the needs of the end-user individuals in the group;
educating the individual in personal finances and budgeting principles as a prerequisite for approval to purchase the product;
establishing a working relationship with the closed group;
providing and maintaining a source of financing through an installment loan program from an approved network of financial institutions; and
managing the loan program in conjunction with the representation from the system,
whereby the individual is assured of obtaining the system guidance and service availability needed for good value in the purchase of the financed product.

2. The system of facilitating the purchase of an affordable, financed product of claim 1, wherein is further provided the step of providing an application for completion by the individual for the purchase of the product and a loan disclosure video for viewing by the individual.

3. The system of facilitating the purchase of an affordable, financed product of claim 1, wherein is further provided the step of verifying the employment and projecting the income of the individual.

4. The system of facilitating the purchase of an affordable, financed product of claim 1, wherein is further provided the step of assisting the individual in s election of the product for purchase from one of the approved suppliers after the successful completion of the educating step.

5. The system of facilitating the purchase of an affordable, financed product of claim 1, wherein is further provided the step of personal instruction of the individual concerning financial matters during the educating step.

6. The system of facilitating the purchase of an affordable, financed product of claim 5, wherein is further provided the step of providing on-line self-instruction concerning financial matters over a global computer network.

7. The system of facilitating the purchase of an affordable, financed product of claim 1, wherein is further provided the step of system personnel conducting supplier training, monitoring performance and assisting in resolving disputes as a part of the providing and maintaining the approved supplier network.

8. The system of facilitating the purchase of an affordable, financed product of claim 1, wherein is further provided the step of establishing an on-site facility where the group is present to allow direct contact with the individual.

9. The system of facilitating the purchase of an affordable, financed product of claim 1, wherein is further provided the step of limiting eligibility to qualify under the loan program of the network of financial institutions to a payment schedule of approximately 30% of income.

10. The system of facilitating the purchase of an affordable, financed product of claim 1, wherein is further provided the steps of assisting the individual in establishing good credit history, purchasing of insurance to cover the product, making prompt payment and servicing of the loan and exit counseling, all as a part of the managing the loan program.

11. The system of facilitating the purchase of an affordable, financed product of claim 1, wherein is further provided the step of establishing supplier performance assurances to meet after-sale requirements to help establish and maintain the integrity of the system as a part of the providing and maintaining the approved supplier network.

12. The system of facilitating the purchase of an affordable, financed product of claim 11, wherein is further provided the steps of establishing a manufacturer's warranty and service contract as a part of the providing and maintaining the approved supplier network.

13. The system of facilitating the purchase of an affordable, financed product of claim 1, wherein the product being purchased is a vehicle.

14. The system of facilitating the purchase of an affordable, financed product of claim 11, wherein the closed group is made up of individuals that are enlisted military personnel.
